(19) United States
(12) Patent Application Publication
(10) Pub. No.: US 2006/0100898 A1
(43) Pub. Date: May 11, 2006

(54) Method for booking and scheduling actors for projects using a computer network

(76) Inventors: Jonathan Parker Pearce, Santa Monica, CA (US); Robert Breton Phillips, Gallatin, TN (US)

Correspondence Address: Jonathan Pearce;Kleinberg & Lerner, LLP, Suite 1080, 2049 Century Park East, Los Angeles, CA, 90067, US

(21) Appl. No.: 11/272,377

(22) Filed: Nov. 10, 2005

Related U.S. Application Data
(60) Provisional application No. 60/626,992, filed on Nov. 10, 2004.

(51) Int. Cl. G06Q 99/00; G06F 15/02

(52) U.S. Cl. 705/1; 705/10; 705/9

(57) ABSTRACT

A method for creating and storing actor profiles in a computer database which may then be searched by producers seeking to cast background or extra roles for projects. The actor profiles are detailed, including all desired physical appearance data, typically including a headshot or bodyshot, which may be used by the producer in selecting background actors. Upon selection the actor is then automatically scheduled or a schedule request is sent and confirmed for a role. The producer may then quickly and easily cast background and other roles, based upon very specific criteria quickly and easily.

This application claims priority based upon the provisional patent application Ser. No. 60/626,992 entitled method and apparatus for booking and scheduling individuals for events using the Internet filed on Nov. 10, 2004.

### BACKGROUND

1. Field of the Invention

The present invention relates to the event scheduling, more specifically to a method of and apparatus for scheduling individuals for events using a computer network.

2. Background of the Invention

The process of a background or “extra” actor making himself or herself available for work is currently complicated and expensive. First, the actor must pay a fee to a booking company or other similar agency to list the actor's characteristics in a hard-copy binder or other filing means. The actor's characteristics are catalogued so that a producer, casting director or director can easily access individuals for a particular background role who fit the desired characteristics. The background actor pays for the privilege of being in the catalogue. The producer, casting director or director then pays the same service a fee for each actor provided using the service. As a part of this fee, the agency makes sure that the actors have current guild memberships (if required) and that they do actually fit the description provided in the catalogue.

A means by which this process could be simplified and streamlined is desirable. Cutting much of the work provided by the casting service would considerably lessen the expense for a background actor. The method of this invention also provides a more convenient means of access for the actor and the producer, casting director or director.

It is therefore an object of this invention to make access to one's profile or catalogue less complex for the actor. It is also an object of this invention to provide a simple means of access to one's profile for the actor. It is another object of the present invention to provide simple access to this catalogue of actors to the producer, casting director or director. This and other objects of the present invention will be apparent from the following description of the invention.

### SUMMARY OF THE INVENTION

The following is a description of a network-based method of booking and scheduling individuals for events. The invention as described herein is most readily applicable to the booking and scheduling of background actors for filming shoots over the Internet. Using this method an actor may login to a particular website, enter his/her personal details related to being booked for jobs including black-out dates when the actor will not be available. This data may be verified, especially photos of a particular actor, using some means of verification. The internet website is used to store the information for each actor. A casting director or producer may then login to the website using some verification means and is presented with a means to select different types of background performers for a particular television show, theatrical production, dramatic production or commercial. The casting director or producer may then select particular attributes that are requested for a particular background actor or group of actors. The casting director or producer is then presented with actors who fit or generally fit the type of actor that has been requested. The casting director of producer may then select the particular actors based upon her preferences or needs for a particular production and the information provided by each actor. The actor is electronically booked on the project, and then notified of such booking.

### BRIEF DESCRIPTION OF THE DRAWINGS

FIG. 1 is a depiction of some of the steps of the method of this invention and where they take place in relation to each other.

FIG. 2 is a flowchart of the actor's side of the preferred embodiment of this invention.

FIG. 3 is a flowchart of the producer's side of the preferred embodiment of this invention.

FIG. 4 is a flowchart of the server side of the preferred embodiment of this invention.

### DETAILED DESCRIPTION OF THE INVENTION

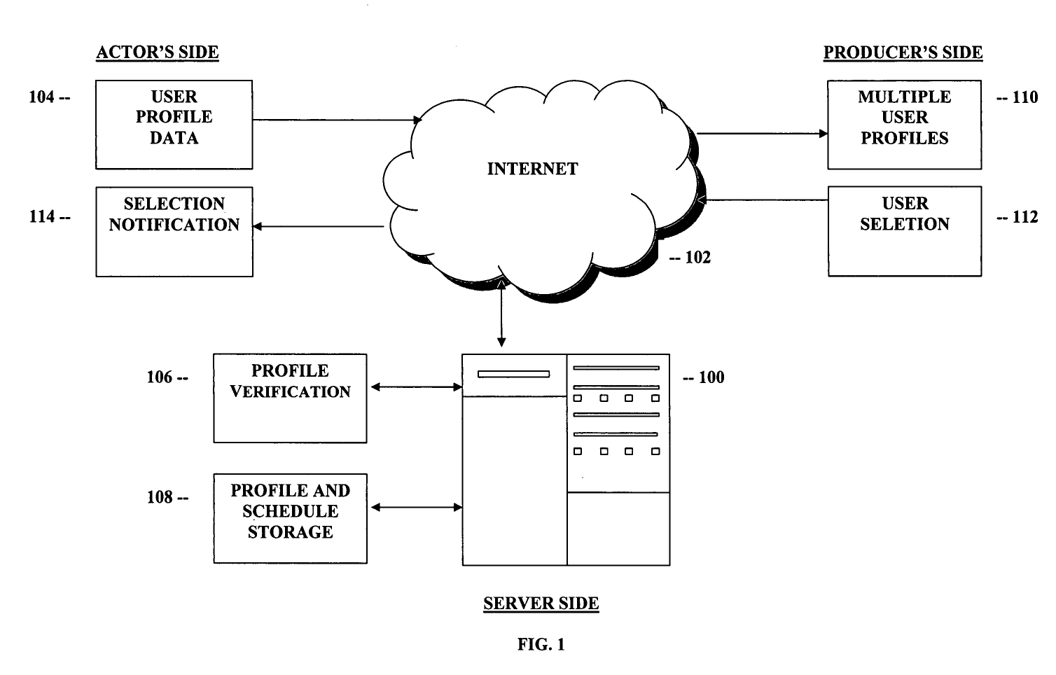

Referring first to FIG. 1, a depiction some of the steps of the preferred embodiment of this invention is depicted, including where they take place. The first major component is the server 100. The server may, in fact, be multiple servers, including a web server and a database server, for example. This server or servers are used to handle actor and producer login requests, to provide the web-based interface to the users and to store profiles and scheduling data. The next component depicted is the Internet 102. This component is the World Wide Web, which is used in the present application to enable the communication between the actor users, the producer users and the server or servers. Alternatively, this may be a closed network of any type, accessible only to those who will be using the site.

The first step depicted is the input of user profile data 104 by the actor. This data is sent over the Internet 102 to the server 100. Here, the profile data is verified 106 by some means. The preferred methods of verification are described below. Once the profile has been verified, then the profile is stored 108. In the preferred embodiment, a database server would be used to store the numerous profiles and schedules which will be created and updated. In the next step, the producer requests an actor or actors. The server 100 then sends the producer multiple user profiles 110 to peruse and to choose among. The producer then makes a selection 112 of which actors to attempt to schedule. This request is sent to the server 100 to view the actors schedule which is held in storage 108. Once the actor's schedule is found to be acceptable, a selection notification 114 is sent to the actor, through whatever means has been chosen. In the preferred embodiment, the actor is automatically scheduled, though schedule acceptance may also be used. Also in the preferred embodiment, the selection notification is sent via email, text message, telephone call or facsimile, though numerous other methods and methods not yet widely-used may also be employed for notification.

The Actor's Side

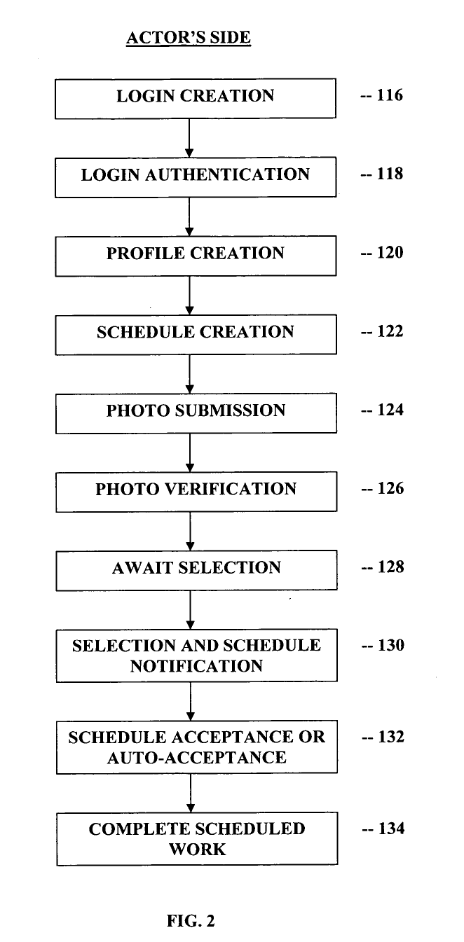

Referring next to FIG. 2, a flowchart depicting the steps of the preferred embodiment of the actor's side of this invention is depicted. It is to be understood that this “side” need not necessarily only be for actors. Additional types of creative talent involved in the creation of production content may be scheduled using this process. Temporary set design teams, lighting, or other types of related workers may also be scheduled using the method of this invention. Additionally, this invention may be used to schedule workers for large-scale events and the like. Actors is only seen as the preferred embodiment of the invention, though it may have many other uses.

A website is created that allows for an individual login to a website. Using a particular authentication number or simply using a custom-created login, a login for an individual is created 116. The user must then be authenticated as an actor in the preferred embodiment. Login authentication 118 may use among other things, a Screen Actor's Guild membership identification number, Actor's Equity Association, American Film, Television and Radio Association. The Screen Actor's Guild membership numbers are typically eight digits long. Other individual identification may be used, but generally some verification is needed for this particular application that the actor is a member of an appropriate group who is allowed to access this website. After the initial login, the actor may then create an individual login, no longer requiring that they use their unique ID membership number.

Upon first login, the actor is then asked to create a profile. The profile creation 120 process is used to clearly identify the individual actor using numerous types of data which may be searched for by a producer in requesting background actors for projects. The actor is presented with a number of data input boxes and radio buttons or checkboxes. These data input boxes include locations for: name, age, address, telephone number, email address, and cell phone number. There are radio buttons, checkboxes or dropdown menu for: race, nationality, sex, height, weight, eye color, hair length, hair color, degree of scruffiness (clean cut, scruffy or beard).

The next step is to create a schedule 122. The actor is presented with a means, similar to a calendar, wherein the actor can select particular days or weeks when the actor will be unavailable to work. The actor may also select individual hours on those days or weeks when the actor will be unavailable. These unavailable times may only be set up to one year in advance. The actor may also select a radio button which when selected would indicate that the actor is available, if otherwise unscheduled, for a “rush call” on a less-than-one-day request for scheduling automatically. The actor also selects the desired means of contact: text message, phone call, email or fax. This is used when the actor is selected for a particular project to confirm their appearance on that day and time. The actor may also at her option select to input a minimum 8-hour daily rate. They are not able to bid below the current minimum daily rate for their guild, for example, the Screen Actor's Guild minimum daily rate.

Next an actor must submit one or more photos 124. The actor submits these photos or even a video clip via the website. Generally, this will be a headshot or reel. Other photos may be submitted, but only up to three total photos. The photos must be verified 126, by some means in order to ensure that the individual's pictures or reels are actually themselves or their work. Individual monitoring the photo submission process, as they are submitted, is used in the preferred embodiment to verify the validity of the headshot. Alternatively, as a user registers for his/her Screen Actor's Guild, AFTRA or AEA identification, the user takes one photo and this is used as the headshot. The user may then update the headshot, by bringing in a photo at the time of registration or at a later time. The additional photos may be updated at any time, but the single headshot must be verified by some means. The actor inputs this data and may update the data at any time using his/her login.

The actor then awaits selection 128 for a project by a producer. This process will be described below. Once the user is selected, he or she will be notified of their scheduled times 130. In the preferred embodiment, the schedule is automatically accepted 132, that is the actor will be scheduled and expected to arrive at the scheduled time immediately upon selection. In alternative embodiments, the actor may be sent notification of selection and the times for which he or she is requested and must accept the scheduling. At this point, barring scheduling conflicts, the user may be returned to the await selection 128 in the flow chart and may be selected for additional work. Finally, the actor shows up to the scheduled project on time and completes the scheduled work 134.

The Producer's Side

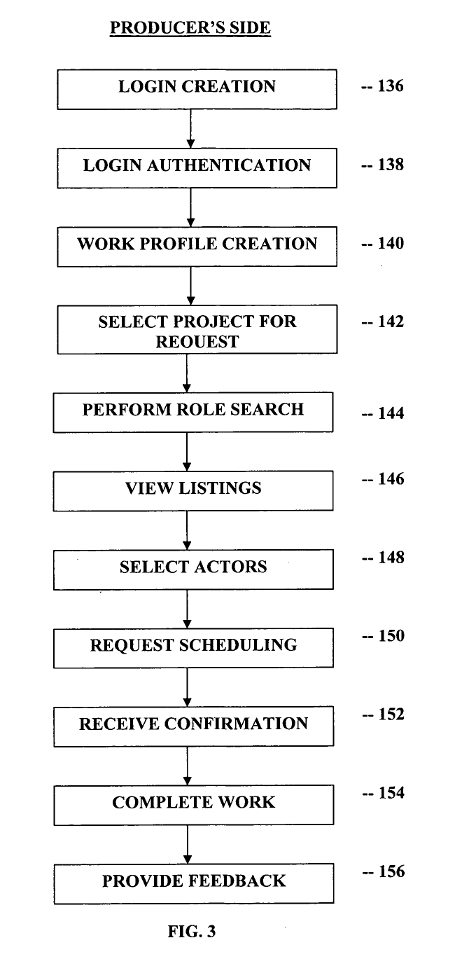

Referring now to FIG. 3, a flowchart of the steps of the preferred embodiment as seen from the producer's side is depicted. It is to be understood that producer's may be directors, casting directors or other individual's responsible for casting a production. Additionally, the “producer's” side may also be used by any individual required to find large numbers of specific people and schedule them for events or productions of any type. The producer website consists of the same or similar login which must be created 136 upon initial login by the producer. The producer (or directors or casting directors) must be authenticated 138 as well to ensure that they are, in fact, casting for an actual television, radio, theatrical or cinematic production. They may be authenticated using a Director's Guild of America identification number or some other suitable identification number. This number is used to verify the identity of a particular producer working on a particular television show, theatrical production, dramatic production or commercial. The producer may then change the login to a custom login, no longer requiring the Director's Guild of America identification number or other verification number.

Next, upon first login, the producer must create a profile of the work which will be cast 140. Television shows, commercials, theatrical or dramatic productions are added to the database of shows for a particular producer, casting director or director each day or week when the projects become a Screen Actor's Guild signatory project. This is done by a party at the Screen Actor's Guild. The same is true for AFTRA or AEA projects. So, when a new show is created and the Screen Actor's Guild or other suitable group signs on officially, a database is updated at the website to include that show on the producer's, casting director's or director's first page after login. Alternatively, the producer will add the show, film or other dramatic production to the database which will subsequently be verified by the particular guild involved, SAG, AFTRA or AEA, for example. Using this method, the producer would be unable to book actors for a particular show until the production is verified in some way.

After the producer's first login and creation of the work profile 140, the producer will then see the list of available projects. The producer will select the project for a casting request 142 from a list of projects for which they are allowed to select actors. After the producer selects a particular project, the producer is presented with the dates of that project. The producer then selects a single day and time or a number of days and times. The producer will then perform a role search using numerous traits which the producer may request in his or her background actors. For the days selected, the producer is presented with a group of radio buttons, drop-down menus and checkboxes in order to layout the traits requested for the particular part. The producer may select any, one in each category, or none of the traits. There is also a further drop-down menu to select the number of actors matching this description that he wishes to schedule. The producer then selects the traits, including: race, nationality, sex, height, weight, eye color, hair length, hair color, degree of scruffiness (clean shaven, scruffy or beard) that are relevant to the particular part needed. A “simple” search may be provided only including: sex, age, and race. The producer may select, though an options page to include all traits or only some traits in the search criteria or simply to use “advanced” search which would include all available traits. The producer may also select to emphasize particular traits, using percentages or a drop-down menu of importance on each trait. Non-selected traits would not be considered in conducting an actor search actors. The producer then submits the request, performing the role search 144, using a submit button. The producer is then presented with a listing of the actors who fit the description (or closely fit the description) dependant upon the information input by the actor above and any emphasis provided by the producer.

The producer may then view this listing 146 of potential actors for the part, given the traits he has selected. Either a “match-up percentage” is presented, with the highest “matching” actors listed first, or the producer may choose, alternatively, to only see actors who fit all of the requested traits. This listing is presented as a large group of headshots side-by-side. Alternatively, the producer may select in an options page to have different layouts, such as one presenting each headshot with a small detail description of each actor including many or most of the details that the actor has input alongside the headshot. Each headshot has a radio button or similar selector next to it in either display type. The producer may then select actors 148 and the number of actors he or she wishes to schedule for that time-frame and show. The actors that are presented in the listing will have already been screened to be available for that time-frame. In alternative embodiments, all actors will be shown, regardless of scheduling and a schedule request 150 will be sent to an actor upon request by the producer. Next, the producer will receive confirmation 152, immediately if the actor is set to “auto-accept” scheduling or upon receipt and positive response by the actor to a scheduling request by the producer.

At this point, the producer may return to selecting a project and time for additional requests 142. The producer may then select to return to the prior page and enter new traits and a new number of actors for a particular day or week and time. The producer is then presented with a number of actors who fit the description of the traits requested and may then select appropriate desired actors from this list. The producer may also indicate a number of alternate actors for each search, up to twice the number of actors needed for a part. As a producer is selecting a group of actors, another producer may be logged in selecting a similar group. If an actor is selected by the producer, during that time, for 15 minutes that actor is unavailable to be presented to another producer using the site. After this time period has passed and the actor has not been selected, the actor will be marked as “available” again. After the producer has selected each group of actors, she is presented with a summary of costs for this show on this day based upon the minimum daily rate or each actor's selected minimum daily rate.

The actor will then complete the work 154. The producer will then be presented with the opportunity to provide feedback 156 about the actor, but feedback is optional. This feedback will be used to “rate” each actor for “reliability.” As the producer views each headshot, the producer will also be presented in the preferred embodiment with a ranking of the actor's “reliability” as determined by their consistency having been ranked by prior hires. If the actor has shown up to each job or to most jobs that they are booked for, then the actors ranking will be fine. In the preferred embodiment, the actor will be ranked, optionally, by the producer who hired them after the job has been completed. A reminder will be sent, via email, to the producer to complete a feedback form online for the particular actor. These rankings will be aggregate, so that the effect of a single angry producer will not be able to ruin an individual actor's ranking.

Once an actor has been selected by the producer an email, text message, phone call or fax is sent to each of the actors by the website depending upon the preferred method of contact chosen by the actor. The actor then has the opportunity to respond in confirmation or rejection to the particular show and scheduled time using any of the means used as the preferred means of contact. For example, a text message user would receive a text message naming the producer, the show, the date and time of the booking and the appropriate response to accept and reject. A user could then respond to the text message with, for example, a “confirm” or a “reject” response via text message.

Once the producer logs out, a summary of the bookings requested is sent, via email or fax to the contact email or fax by the website. This confirmation, as depicted in element 152 of FIG. 3, is fairly detailed and is organized per-project, per-day. This will be a summary of all actors requested. Each day or immediately, as the producer has selected to receive confirmations, thereafter summaries or individual confirmations of bookings will be sent via email or fax to the producer. Preferably, this would be in summary form at the end of each day. If the actor fails to respond, it is assumed after one day that they have rejected the request for booking. If the actor fails to respond, the producer has the option of “blackballing” that actor for the remainder of this production. This would mean that for that particular production, the actor's face would no longer appear in any search request unless they are an exact match. If the request by the producer is made one day before the scheduled production, then the request is rejected unless there is a response within thirty minutes. If the request is made the day of the requested scheduled time, then the actor will receive the schedule confirmation automatically, if they have selected the radio button stating that they are available for the “rush call.” If they have not selected this radio button, they will receive a confirmation request and have thirty minutes to respond, before being automatically rejecting the request. Alternate actors will automatically be contacted and confirmation requested as the primary requests come back as rejections.

The producer then receives a summary of the confirmed workers in whatever means of contact they have selected once the actors are completely scheduled including the contact information from the website input by the actors who have been scheduled for that day and time. The producer may choose to receive verification by email or fax.

The Server Side

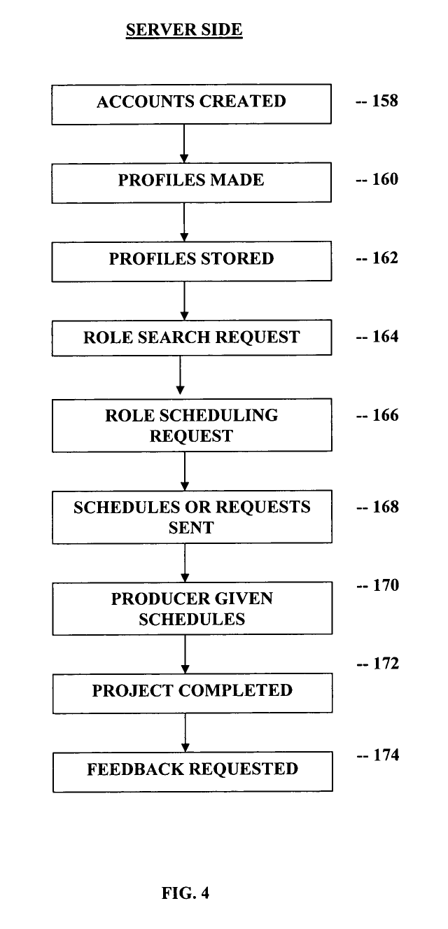

Referring now to FIG. 4, a flowchart depicting the steps of the preferred embodiment of the server side is shown. The first step, from the server side, is the account creation 158. This is when the actor or producer creates an account with a login. In the preferred embodiment, as described above, the account creation process will involve some verification that the actor or producer is actually a member of an acting guild or is actually producing a production of some type. In the preferred embodiment, this is done by cross-checking a database of already-input projects which are received by contacting various guilds, director's, writer's and acting guilds.

The next step is the profile creation 160. This is where the actors create their individual profiles, including headshots or reels. The producer's side will consist of the profiles and schedules of shows. The server will receive role search requests 164 looking for the particular traits. The server will then search its database of actor profiles to present the producer with all potential actors. Once the producer has made his or her selection, the role schedule request 166 will be sent to the server. The server then either auto-schedules the actors, if it is so set up, or requests schedule confirmation from the actors 168. The producer is then forwarded the schedules 170 for each actor and production he has created, via facsimile, text message or email. The project is completed 172, using the scheduled actors and the server then requests feedback 174, which is either given or not given and then added to the actor's profiles.

It will be apparent to those skilled in the art that the present invention may be practiced without these specifically enumerated details and that the preferred embodiment can be modified so as to provide additional or alternative capabilities. The foregoing description is for illustrative purposes only, and that various changes and modifications can be made to the present invention without departing from the overall spirit and scope of the present invention.

What is claimed is:

1. A computer-based method of booking actors for projects comprising the steps of:
searching a computer database of actor profiles;
selecting an actor from said computer database; and
scheduling said actor for a project.

2. The method of claim 1, wherein said searching step is preceded by the following steps:
creating an actor profile, including actor schedule availability; and
storing said actor profile in a computer database.

3. The method of claim 1, wherein said searching step is preceded by the step of creating a project schedule.

4. The method of claim 1, wherein said searching step includes the selection of individual traits desired by a producer in a particular actor.

5. The method of claim 2, wherein said scheduling step is completed automatically based upon said actor schedule availability.

6. The method of claim 1, wherein said scheduling step is completed after a request for schedule confirmation from said actor.

7. The method of claim 1, further comprising the additional step of providing feedback about said actor.

8. The method of claim 2, wherein said actor profile includes at least one photo of said actor.

9. A computer-based method of selecting an actor from a database of actors for a project comprising the steps of:
selecting traits desired in an actor;
requesting a search of the database based on said traits;
receiving results of said search; and
selecting the actor based upon said results.

10. The method of claim 9, further comprising the additional step of scheduling the actors for the project.

11. The method of claim 9, wherein said selecting traits step is preceded by the following steps:
inputting an actor profile data, including actor schedule availability; and
storing said actor profile data in the database.

12. The method of claim 11, wherein said scheduling step is completed automatically based upon said actor schedule availability.

13. The method of claim 10, wherein said scheduling step is completed after a request for schedule confirmation from said actor.

14. The method of claim 9, further comprising the additional step of providing feedback about said actor.

15. The method of claim 11, wherein said actor profile data includes at least one photo of said actor.

16. A computer-based method of booking actors for projects comprising the steps of:
creating an actor profile, including actor schedule availability and at least one photo of said actor;
storing said actor profile in a computer database;
searching a computer database of actor profiles using individual actor traits;
selecting an actor from said computer database based on said actor traits; and
scheduling said actor for a project.
